(19) United States
(12) Patent Application Publication
(10) Pub. No.: US 2012/0278277 A1
(43) Pub. Date: Nov. 1, 2012

(54) OBJECT-BASED MODELS IN DOCUMENT MANAGEMENT

(75) Inventors: Niranjan Dilip Marathe, Plano, TX (US); Krishnan Srinivasan, Plano, TX (US); Sarang Shashikant Bapat, Pune (IN)

(73) Assignee: SIEMENS PRODUCT LIFECYCLE MANAGEMENT SOFTWARE INC., Plano, TX (US)

(21) Appl. No.: 13/245,936

(22) Filed: Sep. 27, 2011

Related U.S. Application Data
(60) Provisional application No. 61/480,856, filed on Apr. 29, 2011.

(51) Int. Cl. G06F 17/30

(52) U.S. Cl. 707/609; 707/E17.005

(57) ABSTRACT

Product Data Management systems, methods, and mediums. A method includes receiving a document component that includes business objects. The method includes receiving a document automation component. The method includes reading a document management part of the document component, and constructing a document model based on the document management part.

### CROSS-REFERENCE TO RELATED APPLICATION

This application claims the benefit of the filing data of U.S. Provisional Patent Application 61/480,856, flied Apr. 29, 2011, which is hereby incorporated by reference.

### TECHNICAL FIELD

The present disclosure is directed, in general, to computer-aided design, visualization, and manufacturing systems (“CAD systems”), product lifecycle management (“PLM”) systems, and systems that manage data for products and other items (individually and collectively, product data management (“PDM”) systems).

### BACKGROUND

PDM systems can provide users with helpful and intuitive views of systems, objects, topologies, and other items.

### SUMMARY OF THE DISCLOSURE

Various disclosed embodiments relate to systems and methods for working with object based models, for example in document-centric tools, in a manner that can be transparent to the end user.

Various embodiments include PDM systems, methods, and mediums. A method includes receiving a document component that includes business objects. The method includes receiving a document automation component. The method includes reading a document management part of the document component, and constructing a document model based on the document management part.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in which an embodiment can be implemented;

FIG. 2 illustrates components in accordance with disclosed embodiments; and

FIG. 3 depicts a flowchart of a process in accordance with disclosed embodiments.

### DETAILED DESCRIPTION

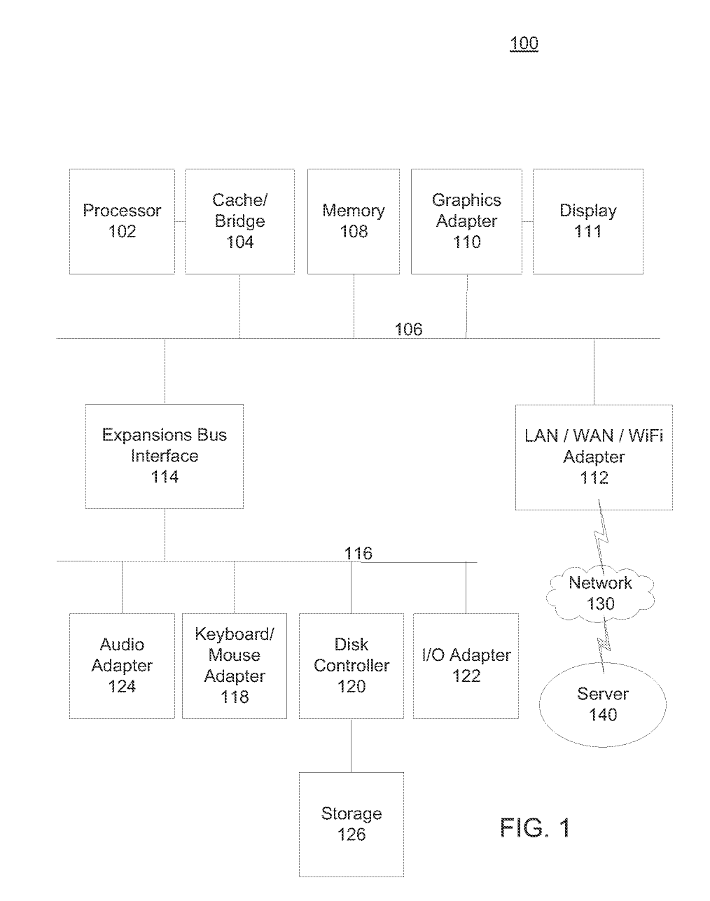

FIGS. 1 through 3 and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

In product development, requirements play a crucial role. Typically these requirements are created, routed for reviews or approval, and then live in the system as business objects. Arranging the business objects in logical hierarchies is one way to visualize product requirements. More refined and granular requirements become children of coarser or broader requirements. The process generally includes exporting objects' content to a document, modifying contents while working within the document, and saving the document back to database and thus modifying the underlying business objects.

The modification of business objects in a document involves editing contents, creating new objects based on existing ones, creating logical hierarchies or “structures” of objects, and managing the structure in terms of re-parenting nodes, removing exiting nodes, and changing node position in the hierarchy, etc. Since these objects represent “entities” in particular business domain, end users like to create traceability between them while working in a document.

Disclosed embodiments provide end users the best of both worlds; i.e., the system uses the document-centric approach to author or modify the object content, and at the same time the system can use business operations like creating traceability, structure management, locking objects for modification by other users, workflow, etc. These other business options are not supported in known document-centric solutions.

The various embodiments discussed in more detail below include improved systems and methods for working with object based models in document-centric tools transparent to the end user.

FIG. 1 depicts a block diagram of a data processing system in which an embodiment can be implemented, including as a data processing system particularly configured to perform processes as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

Disclosed embodiments can be implemented using one or more data processing systems 100 to enable users to work with object based models in document-centric tools using disclosed techniques that are transparent to the end user.

Many times documents are used to author and modify initial requirements, and are associated with business objects. This process can include steps of uploading existing documents to a server, parsing document on the server according to a pre-defined algorithm, and creating business objects out of the document contents.

After that, business applications can be used to carry out business operations on the business objects, including by not limited to creating traceability, structure management, locking objects for modification by other users, workflow, etc. This two-step process can hamper productivity. Additionally, having contextual information of object structure is an aid to users in modifying, adding new objects, and creating traceability. Disclosed embodiments also help users to navigate within the document for quick access to the objects of their interest.

Various systems and method disclosed herein provide end users ability to work with business objects in a document with enough contextual information to carry out business operations on them and maintain logical hierarchies. The operations can be completely transparent to end users.

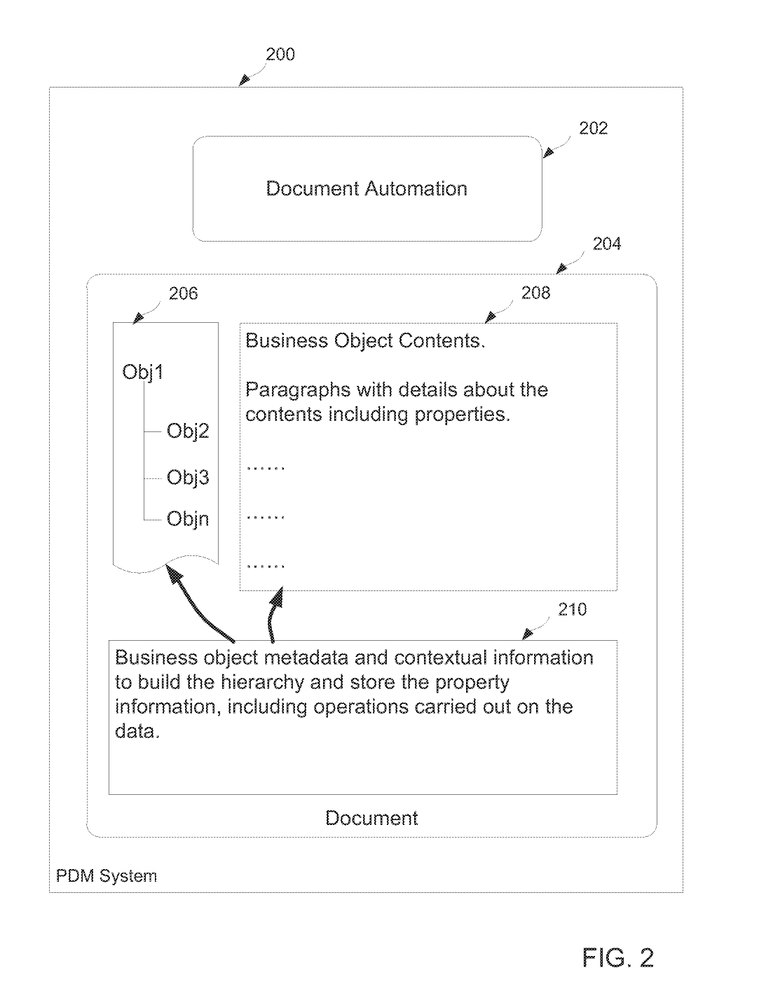

FIG. 2 illustrates components in accordance with disclosed embodiments, illustrating a PDM system 200 and components as described below. PDM system 200 can be implemented as one or more data processing systems 100, and for clarity of illustrations, the hardware features shown in FIG. 1 are not reproduced in this figure.

Disclosed embodiments can generate a document with business objects contents. This document has all the contextual metadata about the business objects it contains. This allows a user to carry out business operations like adding new objects, modifying the logical hierarchies of objects, workflow routing, and editing object contents, also referred to as “properties”. After end user is done with these operations, he/she can save the work back to the business application without ever leaving the document.

Disclosed embodiments include a document automation component 202. This component is used for parsing metadata, constructing an object model for the document, and rendering various views in the document. Document automation component 202 can also carry out various business operations on the business objects present in the document.

These business operations can include creating new business objects, promoting/demoting objects in logical hierarchies, locking objects for editing, viewing object properties, and others.

Disclosed embodiments also include a document component 204. Preferably, but not necessarily, this document is compatible with the Open XML format. In various embodiments, the document can include one or more of the following parts that can work together to display various views of business objects, store the object state, etc.

The document component 204 can also include a document views part 206 that forms the various views that are used to display business objects in a document. A logical hierarchical view, such as illustrated in FIG. 2, is one such view. Various ones of the business operations can be supported through these views. For example, the document views part 206 can implement user interactions such as right click menus, keyboard shortcuts, and others.

The document views part provides logical views of the document contents.

The document component 204 can also include a document management part 210, which can be implemented as a custom XML part, that stores such data as the business objects' data, state information for the business objects, hierarchical information, and metadata about the business objects such as type of properties, length of data fields, etc. This data can include business object metadata and contextual information to build the hierarchy or other document views and store the property information, including operations carried out on the data. In various embodiments, this data is saved with the document, which allows it to be used in an offline mode. This part can act as a repository for a document model object and can persist the document state to the custom XML.

The document component 204 can also include the document contents 208, which includes the business object contents, paragraphs with details about the contents, and other data. Document contents 208 can include properties of the business object contents.

The document automation component and document component can be used by the system to implement various functions and processes described herein.

In some embodiments, the document model is a model that can render the requirement structure as well as the paragraphs in an exported document. It provides data binding to various controls and can generate events as the model changes. The document model can host repositories to save the elements described herein. It can use a framework such as those provided by the MICROSOFT OFFICE® software products to carry out these activities, and can also use various word processing software, such as the MICROSOFT WORD® word processing product. The document model can include a document that represents the document being exported and provides interface to interact with the document. The document model can also hold the metadata about the document such as object template used to export, etc. The document model can include a structure that represents or models the requirement structure being rendered and services requests such as new additions to the structure, the promotion or demotion of nodes in the hierarchies described herein, and perform other functions. The document model can include a requirement node that represent or models the individual nodes in the requirement structure. The requirement node can provide services like property updates, traversal of child nodes, etc., and can be implemented as direct wrappers over the custom XML data source.

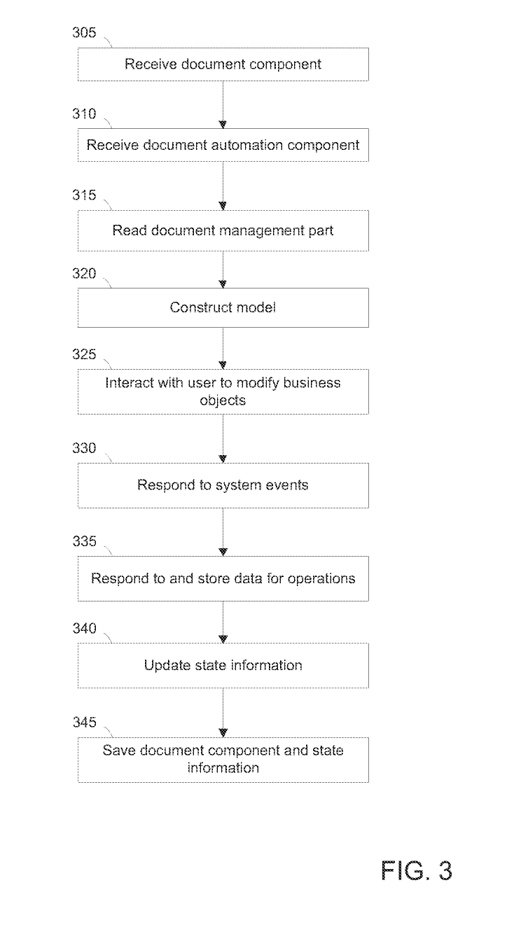

FIG. 3 depicts a flowchart of a process in accordance with disclosed embodiments, than can be performed, for example, by one or more PDM data processing systems, referred to in the singular as “the system”.

The system receives a document component (step 305). “Receiving”, as used herein, can include loading from storage, receiving from another device or process, or receiving through an interaction with a user. This step can be performed in response to a user input to open the document. The documents component can include any of the elements described herein, including business objects and state information for the business objects.

The system can receive the document automation component (step 310). This can be performed concurrently with or in response to receiving the document.

The system can read the document management part (step 315). This step can be performed or directed by the document automation component. As part of this step, the system can determine from the document management part the type of business objects, the state information for the business objects, and if there is any hierarchy present.

The system can construct a document model corresponding to the document component (step 320). This step can be performed or directed by the document automation component. The document model can be based on logical hierarchies, property tables, command handlers for business operations, or localized strings for menus, among others, and in particular can be based on the document management part.

The system can interact with a user to modify business objects in the document by editing the properties and contents as text in the document (step 325). As part of this step, the system can record these actions or perform any corresponding bookkeeping activity. This step can be performed or directed by the document automation component.

The system can monitor and respond to any system events that are produced while a user is editing the document component (step 330). This step can be performed or directed by the document automation component.

The system responds to and stores data corresponding to any operations performed on the business object through other views (step 335), such as the logical hierarchical view. This step can be performed or directed by the document automation component.

The system maintains and updates the state information for the business objects in the document component during and according to the user interaction (step 340). This step can include displaying a warning to a user if any illegal operations are attempted or carried out. This step can be performed or directed by the document automation component.

The system saves the document component (step 345). This step can be performed in response to a user input. This step can include updating the business objects in a database, including the updated state according to the user interaction. This step can include displaying an indication of the success or failure of the save operation to the user.

Unless otherwise described, the various processes, actions, and steps described above can be performed concurrently, sequentially, in a different order, or omitted in various embodiments.

In various embodiments, the techniques disclosed herein enable users to perform operations, including creating new business objects, rearranging the objects within the document, and others, when the document is disconnected from any server system that maintains it. For example, the user can export a structure of Requirements to a document component, disconnect from the server system, and work in offline mode, for example when in an airplane. The user can then later reconnect to the system and the system will use the documents component, including document management part 210 and document contents 208, to merge the changes back in to a server-side version of the document component.

in some embodiments, the system can store some or all of the data discussed above outside of the document component, including by storing business data outside the document used to manage business objects. The data can be stored in XML databases, or other storage mediums, and then used to work within the document. This alternative can add complexity to the deployment of the solution due to an independent deployment of database schemas, install scripts, etc. Additional checks need to be performed during deployment for version compatibility. This variation adds additional cost of licensing the database applications, XML tools used for parsing, etc.

The portability of the document is severely reduced in this variation as the document is no longer self-sufficient in terms of the data it is representing. Users may need to maintain a separate data store if the document needs to be moved as part of workflow applications or any other similar business processes.

Tools catering to the systems engineering domain deal with this type of problem to provide end users with document centric solution to manage business objects. Since systems engineering forms one of the important pillars of product data management and product development, disclosed embodiments are applicable to all the tools in this domain. Various embodiments can be implemented using Open XML standards, so any application which uses these standards can implement the functions and processes described herein.

End users can work with the document completely unaware of the data model used by the system to manage the business objects. The user can edit contents, properties, manage object structures/hierarchies, and carry out other business operations like creating trace links without ever leaving the document itself, which can be, for example a MICROSOFT WORD® data processing document as the document component.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method performed by a product data management (PDM) data processing system, comprising:
receiving a document component that includes business objects;
receiving a document automation component;
reading a document management part of the document component; and
constructing a document model based on the document management part.

2. The method of claim 1, wherein the PDM data processing system interacts with a user to modify the business objects in the document.

3. The method of claim 2, wherein the PDM data processing system monitors and responds to system events that are produced while the business objects are being modified.

4. The method of claim 1, wherein the PDM data processing system responds to and stores data corresponding to operations performed on the business objects.

5. The method of claim 1, wherein the PDM data processing system maintains and updates state information for the business objects of the document component according to a user interaction.

6. The method of claim 1, wherein the PDM data processing system saves the document component, including updating the business objects in a database, and including storing updated state information for the business objects.

7. The method of claim 1, wherein the constructing the document model is performed by the document automation component.

8. A product data management (PDM) processing system, comprising:
at least one processor; and
an accessible memory, wherein the PDM data processing system is configured to:
receive a document component that includes business objects;
receive a document automation component;
read a document management part of the document component; and
construct a document model based on the document management part.

9. The PDM data processing system of claim 8, wherein the PDM data processing system interacts with a user to modify the business objects in the document.

10. The PDM data processing system of claim 9, wherein the PDM data processing system monitors and responds to system events that are produced while the business objects are being modified.

11. The PDM data processing system of claim 8, wherein the PDM data processing system responds to and stores data corresponding to operations performed on the business objects.

12. The PDM data processing system of claim 8, wherein the PDM data processing system maintains and updates state information for the business objects of the document component according to a user interaction.

13. The PDM data processing system of claim 8, wherein the PDM data processing system saves the document component, including updating the business objects in a database, and including storing updated state information for the business objects.

14. The PDM data processing system of claim 8, wherein the constructing the document model is performed by the document automation component.

15. A non-transitory computer-readable medium encoded with executable instructions that, when executed, cause a product data management (PDM) data processing system to:
receive a document component that includes business objects;
receive a document automation component;
read a document management part of the document component; and
construct a document model based on the document management part.

16. The computer-readable medium of claim 15, wherein the instructions cause the PDM data processing system to interact with a user to modify the business objects in the document.

17. The computer-readable medium of claim 16, wherein the instructions cause the PDM data processing system to monitor and respond to system events that are produced while the business objects are being modified.

18. The computer-readable medium of claim 15, wherein the instructions cause the PDM data processing system to respond to and store data corresponding to operations performed on the business objects.

19. The computer-readable medium of claim 15, wherein the instructions cause the PDM data processing system to maintain and update state information for the business objects of the document component according to a user interaction.

20. The computer-readable medium of claim 19, wherein the instructions cause the PDM data processing system to save the document component, including updating the business objects in a database, and including storing updated state information for the business objects.

21. The computer-readable medium of claim 19, wherein the constructing the document model is performed by the document automation component.
